(19) United States
(12) Patent Application Publication
(10) Pub. No.: US 2009/0057396 A1
(43) Pub. Date: Mar. 5, 2009

(54) METHOD AND SYSTEM FOR MULTIPLE ACCOUNT, TOKEN-BASED SINGLE TRANSACTIONS

(76) Inventors: Eric Barbour, Santa Ana, CA (US); Neil Barbour, Santa Ana, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/199,601

(22) Filed: Aug. 27, 2008

Related U.S. Application Data
(60) Provisional application No. 60/968,259, filed on Aug. 27, 2007.

(51) Int. Cl. G07F 19/00

(52) U.S. Cl. 235/379

(57) ABSTRACT

Systems and methods configured to enable a consumer to use a token (such as a magnetic stripe card, a smart chip, a bio-metric tool, etc.) linked to a plurality of financial accounts belonging to the consumer to complete a purchase or a financial transaction are described. The information stored in the token may be used to retrieve information from a central server about the various financial accounts (such as credit accounts, savings/checking accounts, money market accounts, home equity accounts, etc.) belonging to the consumer. The consumer may be presented with the option of making the purchase using either one of his financial accounts or more of the available financial accounts.

### CROSS-REFERENCE TO RELATED APPLICATIONS

This application claims the benefit under 35 U.S.C. § 119(e) of U.S. Provisional Patent Application No. 60/968,259, entitled “METHOD AND SYSTEM FOR MULTIPLE ACCOUNT, TOKEN-BASED SINGLE TRANSACTIONS,” filed Aug. 27, 2007, which is hereby incorporated by reference in its entirety and made part of this specification.

### BACKGROUND OF THE INVENTION

1. Field of the Invention

The present invention relates in general to the field of processing financial transactions using token based transactions.

2. Description of the Related Art

The use of financial products to complete a purchase or a transaction is widespread in both consumer and business fields. A well-known example involves the use of a credit card or a debit card issued to an account holder by a bank or other financial institution. In using the credit card, the account holder incurs some amount of debt which the account holder is expected to pay in full at some later time.

An account holder may have several accounts of different types such as credit accounts, saving accounts, checking accounts, money market accounts, etc. with different banks or financial institutions. Each account typically has its own token, such as a credit card, to enable access to the resources of the account.

### SUMMARY OF THE INVENTION

Systems and methods that allow an account holder to access one or more accounts using a single token, rather than a token for each account, for making a purchase or a financial transaction may be beneficial to the account holder. Example embodiments described herein have several features, no single one of which is indispensible or solely responsible for their desirable attributes. Without limiting the scope of the claims, some of the advantageous features will now be summarized.

In one embodiment, a payment processing system is described. The payment processing system comprises a reading device configured to process a token on behalf of an account holder. The payment processing system further comprises an input device configured to accept an input and an electronic communication system for transmitting information processed from the token or input from the input device to a central server and receiving information from the central server, the central server being in electronic communication with the system for processing a payment. The payment processing system may additionally comprise a display device configured to display a list comprising at least a plurality of financial accounts linked to the token and a printing device.

In one embodiment, a method for processing a payment for making a purchase is described. The method comprises accepting a transaction request, wherein the transaction request comprises information stored on, tied to, or associated with a token and accessing one or more information stores to gather information regarding one or more financial accounts linked to the token. The method further comprises generating for display a list comprising said one or more financial accounts linked to the token and applying funds from one or more accounts linked to the token as a payment for completing a purchase according to a previously determined rule or instructions received.

In one embodiment, a method for processing a payment for making a purchase is described. The method comprises accepting a transaction request, wherein the transaction request comprises information stored on, tied to, or associated with a token and accessing one or more electronic databases to gather information regarding one or more financial accounts linked to the token. The method further comprises calculating an aggregate balance available for transaction. The method also comprises placing a hold on one or more accounts financial accounts and debiting transaction amounts from one or more financial accounts linked to the token according to instructions received or a pre-set rule.

In one embodiment, a payment processing system is described. The system comprises a computing device in communication with a plurality of information stores, wherein the computing device is configured to receive and process a payment request, the payment request comprising information stored on, tied to, or associated with a token. The computing device is configured to access one or more information stores and generate a list comprising one or more financial accounts linked to the token. The computing device is further configured to receive instructions comprising transaction amounts to be debited from one or more financial accounts and process the payment request.

### BRIEF DESCRIPTION OF THE DRAWINGS

The following drawings and the associated descriptions are provided to illustrate embodiments of the present disclosure and do not limit the scope of the claims.

FIG. 1A is a schematic illustrating an embodiment of a system that can be used to complete a purchase.

FIG. 1B is a schematic illustration of an embodiment of a system for processing a payment.

FIG. 1C is a flow chart illustrating an embodiment of a method that can be used to complete a purchase.

FIG. 2 is a flow chart illustrating an embodiment of a method of processing a payment in order to complete a purchase.

FIG. 3 is a flow chart illustrating an embodiment of a method of processing a payment by aggregate approval method.

### DETAILED DESCRIPTION OF CERTAIN PREFERRED EMBODIMENTS

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

The use of credit cards and debit cards linked to a financial account is becoming more prevalent as the migration towards a cashless society continues. An account holder may hold credit or debit cards linked to different types of accounts which he or she may use to make a purchase or to pay for a service. In some instances the account holder of these cards may incur some debt that the account holder is expected to pay at a later time. In addition to facilitating payment for goods or services, the credit and debit cards may provide credit and financial freedom to the account holder and also offer numerous advantages to the account holder.

In most cases, the account holder has the option and ability to use one or more of the available credit and debit cards for a transaction. However, the ability to dynamically maximize benefits from different credit and debit cards or tokens and/or manage one's accounts and financial tools at the point of sale has been cumbersome and time-consuming, or not available at all. The ability to use multiple credit or debit cards for a single transaction may also face similar challenges. For example, to use credit or debit cards linked to a plurality of accounts for a single transaction, the account holder may have to individually present a token or a credit or a debit card linked to each of the different accounts. Presently, in most of the purchases or financial transactions completed, an account holder can make multiple small individual transactions to complete a larger single transaction but not complete a single transaction by simultaneously accessing multiple accounts. The systems and methods described herein allow an account holder to use funds from several different accounts towards a single purchase, yet present a single universal token at the point of sale. Using the systems and methods described herein the account holder at his or her discretion may choose to complete a single purchase or financial transaction by using a single account or dividing the single transaction between multiple accounts, and in the proportion desired.

Certain embodiments of the invention provide systems and methods for linking accounts with presentation instruments for authorizing and processing financial transactions and providing an account holder with the ability to maximize or aggregate his or her available benefits. The available benefits can include but are not limited to cash-back awards, immediate or future discounts, accruing points through use, earning frequent flyer mileage or hotel points, etc. Some embodiments described herein may include a method for utilizing multiple accounts linked to a single credit or debit card or token to complete a single transaction.

In one embodiment of the invention a credit card and one or more accounts (e.g. checking account, savings account, money market account, etc.) may be linked together to a common token. The token may be used at a number of establishments as a form of payment towards merchandise or services. A system designed to accept credit cards or other forms of payment may be configured to accept the token and receive transaction requests. The system may then determine the account or combination of accounts linked to the token that will be accessed to complete the transaction request. The determination of which account or combination of accounts to use is governed by a previously determined set of rules or may be selected by the account holder ahead of time or, in one embodiment, at the point of sale. Thus, the account holder may have all the advantages of multiple accounts while using a single token or presentation instrument.

One possible advantage of having a single token linked to multiple accounts is the ease with which an account holder can add additional accounts to the multiple accounts already associated with his or her token. For example, when making a purchase with a specific merchant the account holder may be asked if he or she would like to open a credit account with that specific merchant that will allow the account holder to avail of discounts and other privileges. Often the account holder will decline the merchant's offer because he or she does not want to carry another card in his or her wallet. With the present invention, the account holder may easily open an account with that merchant and link the new account to his or her existing universal token. Thus, the account holder can enjoy all the benefits and privileges of having an account with that merchant while maintaining a slim wallet. The new account can be linked to the token at the merchant's store front or via the Internet or via telephone or by some other methods.

With a multiplicity of accounts linked to a common token there may be a need for a set of governing rules. In one embodiment, the account holder can establish and use a default set of rules to govern the use of his multiple accounts. For example, in one set of rules the account holder can choose before making a purchase how the available benefits (such as discounts, points, etc.) can be maximized. In one embodiment, the account holder may establish a rule that purchases less than a particular amount be applied solely to the debit card while purchases greater than a particular amount be applied solely to the credit card account. In some embodiments, the account holder may apply purchases with a particular merchant to a particular account or accounts associated with the token. For example, all purchases made at a home improvement store may be applied to the account holder's home equity line of credit. One or ordinary skill in the art will realize that there are many other ways of establishing the set of rules which are not described here.

The account holder may alter the parameters associated with the set of rules or modify the set of rules at his or her discretion. For example, the account holder may be presented with the option of altering the parameters of the set of rules at the point of sale. In some embodiments, the account holder at the point of sale may apply the entire purchase to a pre-set account according to the rule set or override the rule set and partition the transaction amount between several accounts linked to the token. For example, in one embodiment, at the point of sale while using a token, the account holder can have the option of following the default or previously determined set of rules or choosing specific transaction amounts from several accounts held by the account holder as long as the total transaction amount meets the cost of the purchase. The ability for the account holder to override the rule set and have dynamic control over his or her various accounts at the point of sale can be beneficial to the account holder and provide greater freedom and flexibility to the account holder. For example, in one embodiment the account holder can choose not to apply a travel purchase to a credit card that offers reward miles because of an existing large balance on that credit card but instead choose to pay for the travel purchase partly in cash and partly using one or more different credit cards. The account holder can modify the set of rules at the point of sale or a later point in time.

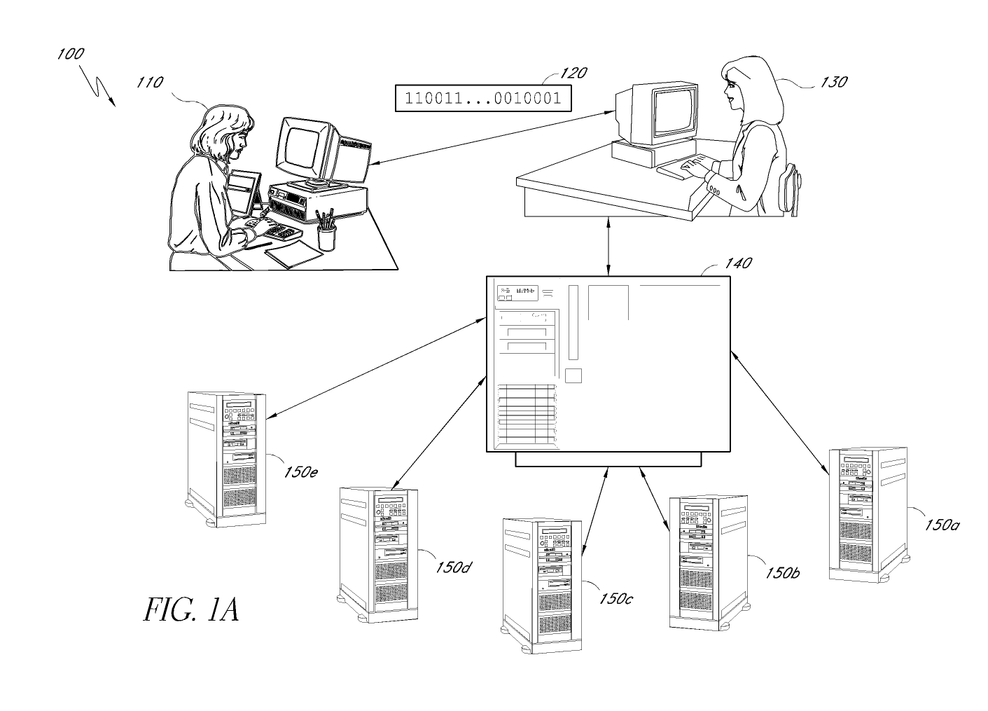

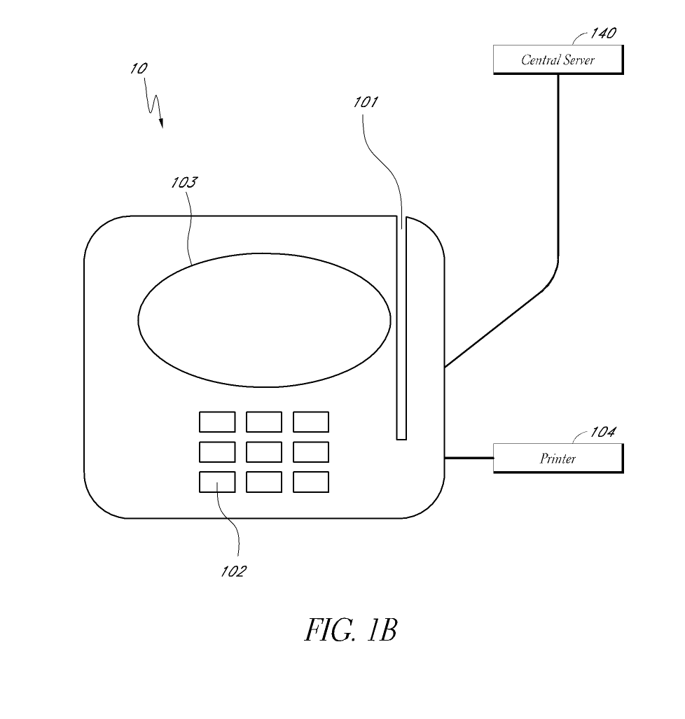

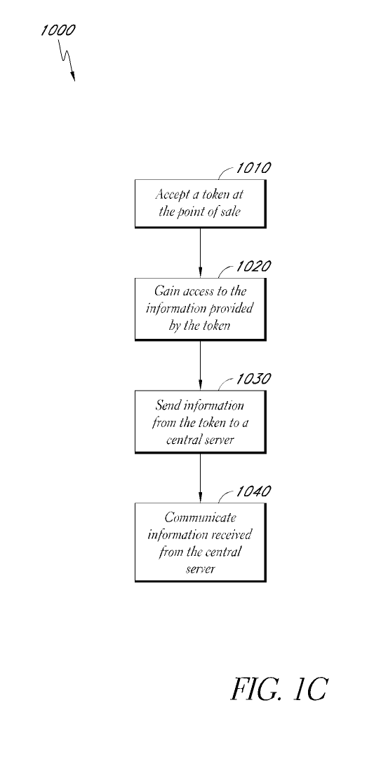

FIG. 1A illustrates an embodiment of a system 100 that can be used to complete a purchase. The embodiment illustrated in FIG. 1A includes an account holder or a user or a consumer 110 who wishes to make a purchase from a merchant or the merchant's representative 130. In some embodiments of the system 100, the merchant or merchant's representative 130 can be located remotely from the account holder 110 and the purchase can be made through an electronic device connected to the Internet, a wireless telephone connected to a wireless network, or a telephone connected to a public switched telephone network (PSTN). One skilled in the art will recognize that other methods of making a purchase from a remote merchant or merchant's representative 130 are also possible. In some embodiments, the account holder 110 can make an in-person purchase from the merchant or the merchant's representative 130 (for example at a store). Other ways of making a purchase not described herein are also possible. To complete the purchase the account holder 110 may use a token 120 as a form of payment for the purchase. The token may represent a vehicle for financial account information and can comprise a multitude of presentation instruments. These presentation instruments may include but are not limited to standard credit or debit cards comprising a magnetic stripe, smart cards that may comprise an electronic chip, key fobs, a biometric tool such as a fingerprint or iris scan, a personal identification number (pin), an alpha-numeric code, a device comprising magnetic ink characters, a device comprising bar codes, a device with a built-in security measure, etc. The token may or may not be associated with an operator of an electronic payment network such as VISA or MasterCard. In some embodiments the token may be issued by a particular bank or financial institution and may link all the financial accounts (e.g. credit accounts, savings accounts, money market accounts, etc.) held by the account holder at that bank or financial institution. One skilled in the art will recognize that other definitions and interpretations of the term token are possible.

The system 100 for completing a purchase may include a central server or an electronic processor 140 in communication with the merchant or the merchant's representative 130 and one or more information stores (e.g. electronic databases) 150a through 150e. The one or more information stores 150a through 150e may be stored in the central server 140 or in one or more remote servers in electronic communication with the central server 140. In some embodiments, the central server 140 may be a part of a central processing network. In one embodiment, the central server 140 may be maintained and operated by a financial processing company. In some embodiments, the central server 140 may be a part of an electronic network such as the Automated Clearing House (ACH). In certain embodiments the central server 140 may be a part of a secure network associated with a particular bank (e.g. Bank of America, etc.) or financial institution (e.g. American Express, etc.). In some embodiments the central server 140 may represent a merchant processor (e.g. First Data) or a clearing house. In some embodiments, the central server 140 may be the central server or a central network for a particular bank or financial institution.

In the system 100 illustrated in FIG. 1A, the one or more information stores 150a through 150e may each comprise a financial account, such as a debit account, one or more merchant accounts, a closed-loop account, etc. For example, the information store 150a may comprise a credit account, such as a VISA account with a particular bank, the information store 150b may comprise a debit account, the information store 150c may comprise a checking account, the information store 150d may comprise a saving account and the information store 150e may comprise a money market account or another credit account, or the like. In some embodiments, two or more information stores may be combined together into a single information store. The above description is not meant to be exhaustive and a person skilled in the art will recognize that the information stores may include information regarding other types of accounts.

FIG. 1B schematically illustrates a system for processing payment 10. The payment processing system 10 may be available for use at the location of the merchant or merchant's representative. The payment processing system 10 may comprise a reading device 101 configured to read or scan the token 120 on behalf of the account holder 110. The payment processing system 10 may further comprise an input device 102 configured to accept an input and a display device 103 configured to display information. The payment processing system 10 may be in communication with a printing device 104 and a central server (e.g. central server 140 of FIG. 1A).

In some embodiments, the reading device 101 may comprise a magnetic stripe reader, a magnetic ink character recognition reader, a scanner, a biometric tool reader (e.g. a fingerprint scanner or an iris scanner), etc. In some embodiments the input device 102 may comprise a key pad or a touch screen. In certain embodiments the display device may comprise LED or LCD screen. In some embodiments the display device may also comprise a touch screen.

FIG. 1C schematically illustrates a method 1000 that can be used to complete a purchase. As described above with reference to FIG. 1A, the account holder 110 can present a token 120 as a form of payment at a point of sale in an attempt to make a purchase from a merchant or merchant's representative 130. The merchant or merchant's representative 130 may accept the token 120 as shown in the token accepting block 1010 of FIG. 1B using a variety of methods. For example in some embodiments, the merchant or the merchant's representative may use the payment processing system 10 of FIG. 1B to read or scan the token 120 from the account holder 110. In some embodiments, the account holder 110 may communicate the details about the token 120 to the merchant or the merchant's representative 130 via the telephone or the Internet and the merchant or the merchant's representative 130 may enter the token details manually or electronically into a form. Other methods of presenting the token 120 and accepting the token details are also possible.

Upon accepting the token 120, the merchant or the merchant's representative 130 may gain access to the information provided by the token 120 as illustrated in the token accessing step 1020 of FIG. 1C. In block 1030 of FIG. 1C, the information acquired from the token 120 is sent to the central server 140 to process the payment. In one embodiment the central server 140 may validate the information from the token 120 and proceed to acquire information regarding all the available accounts linked to or associated with the token 120. The central server 140 may gather information regarding the various accounts linked to the token 120 by accessing one or more internal or external databases (e.g. databases 150a through 150e of FIG. 1A), or whatever system is associated with that account. The central server 140 may communicate the information regarding the various accounts linked to the token 120 to the account holder 110 or the merchant or the merchant's representative 130 electronically. The various steps performed by the central server 140 to process the payment are described in further detail below.

In block 1040, the information received from the central server is communicated to the account holder 110 or the merchant 130. In some embodiments, the information about the various accounts may be displayed to the account holder 110 (e.g. on the display screen 103 of the payment processing system 10). In some other embodiments, the information about the various accounts may be communicated to the account holder 110 via the Internet or telephone.

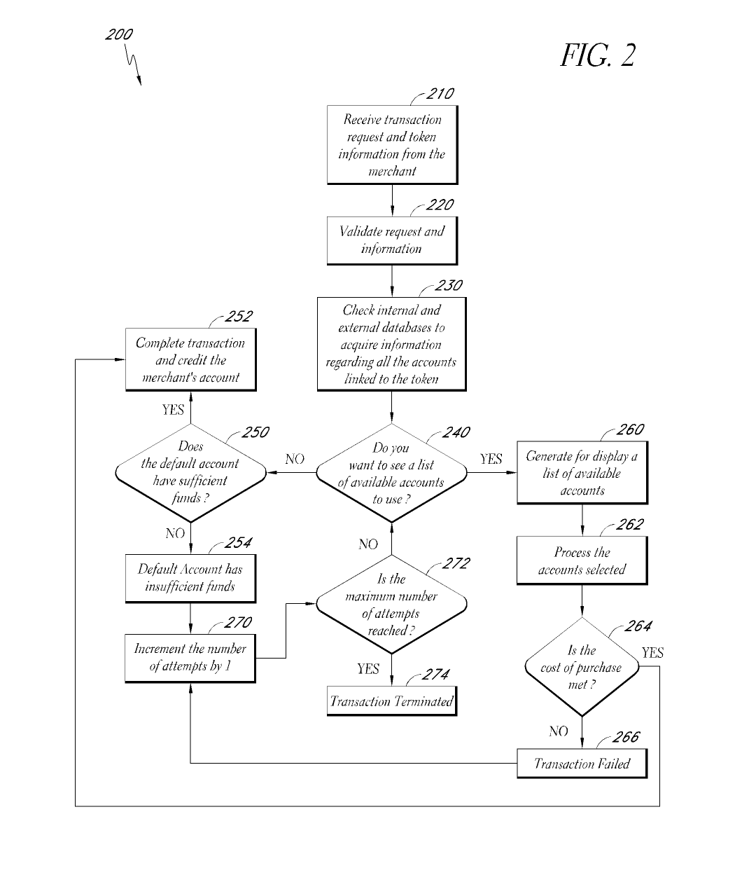

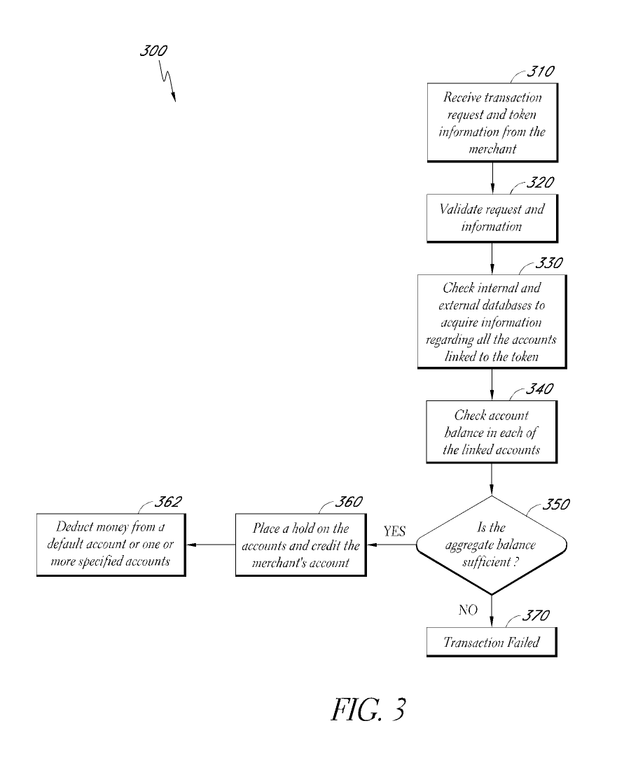

FIG. 2 and FIG. 3 illustrate two embodiments of processing the payment at a point of sale using a token 120. FIG. 2 illustrates a flow chart of an embodiment of a method 200 of processing a payment by a clearing house or a merchant processor in order to complete a purchase. The method of processing a payment 200 comprises one or more of the following steps described below. In block 210 of the method 200, the merchant processor or the clearing house (e.g. central sever 140 of FIG. 1A) receives a transaction request from the merchant or the merchant's representative. The merchant processor or clearing house may validate the transaction request (e.g. by verifying the identity of the merchant) as illustrated in the request validating block 220 of FIG. 2. In some embodiments, the merchant processor or the clearing house may also receive the token details or information acquired from the token along with the transaction request in block 210 of FIG. 2. In some embodiments, the clearing house or the merchant processor may also validate the information acquired from the token (e.g. by verifying the token details or account holder information acquired from the token in one or more databases). On successful validation of the request and the token details, the merchant processor or the clearing house may acquire information regarding the various accounts linked to the token as illustrated in block 230 of FIG. 2. The information regarding the various accounts linked to the token may be acquired in real-time by accessing one or more internal or external database (e.g. databases 150a through 150e of FIG. 1A).

In block 240 of FIG. 2, the merchant processor or the clearing house can communicate with the account holder and query the account holder if he or she would like to see a list of available accounts linked to the token that can be used to make the purchase. In some embodiments, the account holder may also be presented with two choices (e.g. Yes and No) along with the query. If, in block 240, the account holder selects the option to see the list of available accounts linked to the token, then the merchant processor or the clearing house may generate for display a list of available accounts linked to the token, along with the dollar amount available for purchase in each account, to the account holder, as shown in block 260 of FIG. 2. The generated list may be displayed to the account holder. The account holder at his or her discretion may select one or more of the available accounts and communicate the selection to the merchant processor or the clearing house. In some embodiments, the account holder may also provide instructions regarding the transaction amount to be deducted from each of the selected accounts. The merchant processor or the clearing house then processes the selected accounts as shown in block 262 of FIG. 2. The merchant processor or the clearing house can process the selected accounts in a variety of ways; for example, in some embodiments, the merchant processor or clearing house may retrieve the details of the selected accounts from an internal memory or one or more internal or external databases and deduct the dollar amount specified by the account holder from the selected accounts. In some embodiments, the merchant processor or the clearing house may sum the dollar amount deducted from each account and verify that the sum is equal to the payment required for completing the purchase as shown in block 264 of FIG. 2. If in block 264 of FIG. 2, it is determined that the sum of the dollar amount deducted is equal to the required payment then the merchant processor or the clearing house may complete the transaction and credit the merchant's account as shown in block 252 of FIG. 2. In some embodiments, a message that the transaction is completed may be sent to the account holder or the merchant or the merchant's representative.

However, if in block 264 of FIG. 2, the merchant processor or the clearing house determines that the sum of the dollar amount deducted is less than the payment required for the purchase then the merchant processor or the clearing house may send a message to the account holder or the merchant that the transaction was not completed due to insufficient funds as shown in block 266. In some embodiments, the merchant processor or the clearing house may keep track of the number of attempts made by the account holder to complete the purchase. For example, in some embodiments the merchant processor or the clearing house may have an internal counter that is incremented by 1 every time a transaction is not completed as shown in block 270 of FIG. 2. The merchant processor or the clearing house may then compare the number of attempts made by the account holder to complete a purchase with a maximum number of allowed attempts as shown in block 272 of FIG. 2. If in block 272 of FIG. 2, it is determined that the number of attempts made by the account holder is less than the maximum number of allowed attempts, then the method 200 proceeds to block 240 of FIG. 2. If in block 272 of FIG. 2, it is determined that the number of attempts made by the account holder is greater than or equal to the maximum number of allowed attempts, then the method 200 proceeds to block 274 of FIG. 2 where the transaction is terminated and a message may be sent to the account holder or the merchant that the transaction is terminated due to lack of funds.

If, in response to the query described in block 240 of FIG. 2, the account holder chooses not to see a list of available accounts to use, the merchant processor or clearing house may retrieve the details of one or more default accounts from an internal or external database or a memory location. The one or more default accounts may be previously specified by the account holder. The merchant processor or the clearing house may confirm that the one or more default accounts have sufficient funds to cover the payment required for completing the purchase as shown in block 250 of FIG. 2. If in block 250, the merchant processor or the clearing house determines that the one or more default accounts have sufficient funds, then method 200 proceeds to block 252 where the merchant processor or clearing house may complete the transaction and credit the merchant's account with funds from the one or more default accounts.

However, if in block 250, it is determined that the one or more default accounts have insufficient funds, a message may be sent to the account holder or the merchant that the one or more default accounts have insufficient funds. The method 200 then proceeds to block 270 where, as described above, the merchant processor or the clearing house may increment the number of attempts made to complete the purchase by 1. The method then proceeds to block 272 of FIG. 2 where the number of attempts made by the account holder to make a purchase is compared against the maximum number of allowed attempts. If the number of attempts to make a purchase is less than the maximum number of allowed attempts then the account holder may be queried if he or she would like to see a list of available accounts linked to the token that can be used to make the purchase as shown in block 240 of FIG. 2. If however the number of attempts to make a purchase exceeds the maximum number of allowed attempts then the method proceeds to block 274 of FIG. 2 where the transaction is terminated.

FIG. 3 illustrates a flowchart that schematically illustrates an embodiment of a method 300 of processing a payment using an aggregate approval method. In some embodiments of the aggregate approval method various financial accounts belonging to the account holder may be consolidated with one bank or financial institution. The consolidating bank or financial institution may issue a token which can be used to access the different financial accounts held by the account holder. In some embodiments, the consolidating bank or financial institution may manage the various financial accounts. For example instead of receiving bills for each of the different financial accounts, the account holder may receive one bill from the consolidating bank or financial institution that includes details for the different financial accounts.

The method 300 comprises one or more of the following steps described below. In block 310 of FIG. 3, a central server (e.g. a merchant processor, a clearing house, or a central server belonging to a particular bank or financial institution) receives a transaction request along with the token details or information acquired from the token from the merchant or the merchant's representative. In block 320 of FIG. 3, the central server may validate the information request and the token details. For example, in one embodiment the central server may validate the information request by verifying the identity of the merchant. In some embodiments, the central server may also verify the token details or the information acquired from the token by accessing one or more internal or external databases. The method 300 then proceeds to block 330 of FIG. 3 wherein the central server may access various internal and external databases to gather information about one or more accounts belonging to the account holder and linked to the token. In a preferred embodiment, all accounts are checked at once, and continuously or periodically. In some embodiments, the central server may gather information regarding only those accounts (e.g. one or more checking accounts, savings accounts, money market accounts, etc.) that are held by the account holder at a specific bank or financial institution. The method 300 then proceeds to block 340 where the central server may check the account balances in each of the accounts linked to the token and calculate the aggregate balance or the total amount of finds available in all the linked accounts. In block 350, the central server may compare the aggregate balance with the cost of the purchase and determine if the aggregate balance is sufficient. The sufficiency condition may depend on the cost of the purchase and may be set according to a set of rules. For example, in some embodiments, the aggregate balance may be considered to be sufficient if it is at least equal to the cost of the purchase. In some embodiments, the aggregate balance may be considered to be sufficient if it is greater than approximately one and half times the payment required for the purchase. In certain embodiments the aggregate balance may be considered to be sufficient if it is at least 2-3 times the cost of the purchase.

If, in block 350, the central server determines that the aggregate balance is sufficient then the method 300 proceeds to block 360 of FIG. 3. In block 360, a hold may be placed on one account if the one account has sufficient funds to cover the cost of the purchase or several accounts if there is no single account having sufficient balance to cover the cost of the purchase. The hold on the one or more accounts may be placed according to a default rule previously determined. The hold on the one or more accounts may result in a certain amount of money greater than or equal to the cost of the purchase being made unavailable for use until the hold is removed. The central server may communicate with the bank or financial institution where the one or more accounts are held to forward the funds necessary to cover the cost of the purchase to the merchant and credit the merchant's account. In those embodiments wherein the central server belongs to a particular bank or financial institution, the central server may forward the necessary funds to the merchant and credit the merchant's account.

The account holder may be given a specific amount of time (e.g. until midnight on the date of purchase or 24 hours from the date of purchase) to send instructions to the central server or the bank or the financial institution regarding the accounts he or she wishes to use for making the purchase, as well as the amount of funds to be drawn from each of the specified accounts. The account holder may send these instructions at his or her convenience using a variety of ways (e.g. via the Internet, via telephone, etc.). The central server may communicate with the bank or the financial institution to deduct the specified balances from the accounts specified by the account holder upon receipt of instructions as shown in block 362 of FIG. 3. In those embodiments wherein the central server belongs to a particular bank or financial institution, the central server may deduct the specified balances from the accounts specified by the account holder upon receipt of instructions. The holds placed on the one or more accounts may be removed after the balances have been deducted.

In certain embodiments the account holder may instruct the central server, the bank or the financial institution to use one or more credit cards towards the purchase. In these embodiments, the central server, the bank or the financial institution may charge the specified credit cards or collect the balance from the account holder at a later date.

If the account holder does not send instructions to the central server or the bank or the financial institution at the end of the specified period, then the amount of money required to cover the cost of the purchase can be deducted from one or more accounts on which the hold was placed according to a default rule. The default rule may be previously set by the account holder or the bank or the financial institution.

If in block 350, the central server determines that the aggregate balance is insufficient then the method 300 proceeds to block 370 where the transaction is terminated and a message that the transaction was not completed is sent to the account holder or the merchant.

The above described systems and methods may also be used to process multiple foreign currency transactions using a single token. For example, an account holder who travels globally or regularly makes foreign currency purchases can have the facility of accessing one or more financial accounts held in different countries using a single token. In some embodiments, the account holder can pay for purchases made in one country using the currency of another country using a single token. For example, an account holder making purchases in Europe may pay for the purchases in dollars using a single token.

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics may be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

Embodiments of the disclosed systems and methods may be used and/or implemented with local and/or remote devices, components, and/or modules. The term “remote” may include devices, components, and/or modules not stored locally, for example, not accessible via a local bus. Thus, a remote device may include a device which is physically located in the same room and connected via a device such as a switch or a local area network. In other situations, a remote device may also be located in a separate geographic area, such as, for example, in a different location, building, city, country, and so forth.

Methods and processes described herein may be embodied in, and partially or fully automated via, software code modules executed by one or more general and/or special purpose computers. The word “module” refers to logic embodied in hardware and/or firmware, or to a collection of software instructions, possibly having entry and exit points, written in a programming language, such as C or C++. A software module may be compiled and linked into an executable program, installed in a dynamically linked library, or may be written in an interpreted programming language such as BASIC, Perl, or Python. It will be appreciated that software modules may be callable from other modules or from themselves, and/or may be invoked in response to detected events or interrupts. Software instructions may be embedded in firmware, such as an erasable programmable read-only memory (EPROM). It will be further appreciated that hardware modules may be comprised of connected logic units, such as gates and flip-flops, and/or may be comprised of programmable units, such as programmable gate arrays, application specific integrated circuits, and/or processors. The modules described herein are preferably implemented as software modules, but may be represented in hardware and/or firmware. Moreover, although in some embodiments a module may be separately compiled, in other embodiments a module may represent a subset of instructions of a separately compiled program, and may not have an interface available to other logical program units.

In certain embodiments, code modules may be implemented and/or stored in any type of computer-readable medium or other computer storage device. In some systems, data (and/or metadata) input to the system, data generated by the system, and/or data used by the system can be stored in any type of computer data repository, such as a relational database and/or flat file system.

In some embodiments, an account holder as referred to herein may include individuals, groups or companies associated with a particular financial account. Examples of individuals include those who have some form of a financial account with a bank, credit union or financial institution. Groups that are considered to be account holders may include members of a family (e.g. a husband and a wife, a parent and a child, siblings or other family members). Companies that are considered to be account holders may include those that have corporate accounts at one or more financial institutions whether or not they are accessible to the employees of the companies. While illustrative this list is not exhaustive. One skilled in the art will recognize that other definitions and interpretations of the term account holder are possible.

In various embodiments, the term account can include any and all financial agreements, investments or vehicles held by the account holder. In certain embodiments, the account holder can have a single master account comprising or associated with a plurality of accounts that may include savings account, checking account, one or more debit and credit cards, home mortgage account, other loan accounts such as auto or appliance loan accounts, affinity card programs (e.g. an account where an account holder can only make a purchase at a particular merchant location), money market accounts, home equity line of credit, brokerage accounts and other accounts such as social security accounts, retirement accounts, pension plans, health reimbursement accounts, etc.

What is claimed is:

1. A payment processing system, the system comprising:
a reading device configured to process a token on behalf of an account holder;
an input device configured to accept an input;
an electronic communication system for transmitting information processed from the token or input from the input device to a central server and receiving information from the central server, the central server being in electronic communication with the system for processing a payment;
a display device configured to display a list comprising at least a plurality of financial accounts linked to a single token; and
a printing device.

2. The system of claim 1, wherein the token is selected from a group consisting of: cards comprising a magnetic stripe, cards comprising an electronic chip, bio-metric tool, an alphanumeric code, a device comprising magnetic ink characters or a device comprising bar codes.

3. The system of claim 1, wherein the reading device comprises a magnetic stripe reader.

4. The system of claim 1, wherein the reading device comprises a magnetic ink character recognition reader.

5. The system of claim 1, wherein the reading device comprises a bio-metric scanner.

6. The system of claim 1, wherein the reading device comprises a scanning device.

7. The system of claim 1, wherein the input device comprises a key pad.

8. The system of claim 1, wherein the input device comprises a touch screen.

9. The system of claim 1, wherein the display device comprises a touch screen.

10. The system of claim 1, wherein the input comprises one or more transaction amounts to be debited from one or more financial accounts selected from the list comprising a plurality of financial accounts linked to the single token.

11. A method for processing a payment for making a purchase, the method comprising:
accepting a transaction request, wherein the transaction request comprises information associated with a token;
accessing one or more information stores to gather information regarding one or more financial accounts linked to the token;
generating for display a list comprising said one or more financial accounts linked to the token;
applying funds from one or more accounts linked to the token as a payment for completing a purchase according to a previously determined rule or instructions received.

12. The method of claim 11, further comprising generating for display a list comprising said one or more financial accounts linked to the token and the amounts available for transaction in each of said one or more financial accounts.

13. The method of claim 11, wherein the instructions received from the account holder comprises one or more transaction amounts to be debited from one or more accounts selected from the list.

14. The method of claim 13, further comprising verifying that the sum of said one or more transaction amounts is equal to the payment for completing a purchase.

15. A method for processing a payment for making a purchase, the method comprising:
accepting a transaction request, wherein the transaction request comprises information associated with a token;
accessing one or more electronic databases to gather information regarding one or more financial accounts linked to the token;
calculating an aggregate balance available for transaction;
placing a hold on one or more accounts financial accounts linked to the token; and
debiting transaction amounts from one or more financial accounts linked to the token according to instructions received or a pre-set rule.

16. The method of claim 15, wherein calculating an aggregate balance available for transaction comprises calculating the total amount of funds available for transaction in said one or more accounts linked to the token.

17. The method of claim 15, wherein the method further comprises determining if the aggregate balance available for transaction is at least equal to the payment for making a purchase.

18. The method of claim 15, wherein the method further comprises determining if the aggregate balance available for transaction is greater than approximately one and half times the payment for making a purchase.

19. A payment processing system, the system comprising:
a computing device in communication with a plurality of information stores,
wherein the computing device is configured to receive and process a payment request, the payment request comprising information stored in a token,
wherein the computing device is configured to access one or more information stores and generate a list comprising one or more financial accounts linked to the token, and
wherein the computing device is configured to receive instructions comprising transaction amounts to be debited from one or more financial accounts in real time and process the payment request.

20. The system of claim 19, wherein the computing device comprises a merchant processor.

21. The system of claim 19, wherein the computing device comprises a clearing house.

22. The system of claim 19, wherein the computing device comprises a server belonging to a bank or financial institution.
